(19) United States
(12) Patent Application Publication
(10) Pub. No.: US 2007/0097062 A1
(43) Pub. Date: May 3, 2007

(54) Scanning electrode driver, display driver device, and electronic device

(75) Inventor: Munenori Sawada, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/589,390

(22) Filed: Oct. 30, 2006

(30) Foreign Application Priority Data
Oct. 28, 2005 (JP) 2005-313943
Aug. 21, 2006 (JP) 2006-224216

(51) Int. Cl. G09G 3/36

(52) U.S. Cl. 345/100

(57) ABSTRACT

A scanning electrode driver for supplying a drive signal to a plurality of scanning electrodes in a display device having a plurality of display pixels, the plurality of display pixels respectively including memory liquid crystal layers that are applied with drive voltages corresponding to data voltages and scanning voltages when the scanning voltages are applied to the scanning electrodes and the data voltages are applied to the data electrodes, the memory liquid crystal layers being provided corresponding to intersections between the plurality of scanning electrodes and a plurality of data electrodes, and the drive signal being divided into a plurality of phases including at least four phases, the four phases being a reparation phase, a selection phase, an evolution phase, and a non-selection phase, the four phases applying different effective powers to the memory liquid crystal layers, the scanning electrode driver includes a plurality of switch sections, each of the plurality of switch sections having at least one transistor related to one of the data voltages or one of the scanning voltages, the transistor being connected to a target scanning electrode among the plurality of scanning electrodes, and the switch sections each being related to any one of voltages V_{P1} and V_{P2} (which satisfy V_{P1}<V_{P2}) included at least in the drive signal during the preparation phase, voltages V_{S1}, V_{S2}, V_{S3}, and V_{S4} (which satisfy V_{S1}<V_{S2}<V_{S3}<V_{S4}, V_{S1}=V_{P1}, and V_{S4}=V_{P2}) included at least in the drive signal during the selection phase, voltages V_{E1} and V_{E2} (which satisfy V_{E1}<V_{E2}) included at least in the drive signal during the evolution phase, and voltages V_{N1} and V_{N2} (which satisfy V_{N1}<V_{N2}) included at least in the drive signal during the non-selection phase, wherein each of those of the switch sections that are related to the voltages V_{P1} and V_{N1} has an N-ch transistor, each of those of the switch sections that are related to the voltages V_{S1}, V_{S2}, V_{E1}, and V_{E2} has an N-ch transistor and a P-ch transistor which constitute a transmission configuration, and each of those of the switch sections that are related to the voltages V_{P2} and V_{N2} has a P-ch transistor.

The entire disclosure of Japanese Patent Applications No. 2005-313943, filed on Oct. 28, 2005, and No. 2006-224216, filed on Aug. 21, 2006 are expressly incorporated by reference herein.

### BACKGROUND

1. Technical Field

The invention relates to a technology for implementing DDS in a memory liquid crystal display device.

2. Related Art

DDS (Dynamic Drive Scheme) is a known method for driving at high speed a cholesteric liquid crystal display (for example, see U.S. Pat. No. 5,748,277). In employing DDS, a voltage pattern is divided into four phases: a non-selection phase, a preparation phase, a selection phase, and an evolution phase, for application to scanning electrodes and data electrodes in a cholesteric liquid crystal display. Each of the four phases of the voltage pattern includes at least one of eight voltage values (e.g., 0to 70 V). Content is displayed by varying a voltage pattern applied to pixels.

There exists in the art a problem that conventional display drivers are not suitable for use in a DDS. Specifically, no driver has existed which is capable of supplying to scanning and data electrodes each of the eight voltage values used in a DDS.

### SUMMARY

The invention provides a display driver that is capable of satisfactorily supplying each of a voltage used in a DDS.

One example of a driver used in the art that is capable of supplying each of the eight voltage values used in a DDS is a display driver having eight N-channel transistors (hereinafter “N-ch transistor(s)”). The eight N-ch transistors are respectively related to the eight voltage values. Each N-ch transistor has a switch function for connecting a voltage source of a related voltage to a scanning electrode or data electrode. However, such a display driver involves a problem in that it is not capable of satisfactorily supplying either a high or medium voltage. This problem is inherent to N-ch transistors in that they are capable of supplying low voltages, only.

An alternative driver used in the art for supplying the required eight voltage values is a display driver having eight P-channel transistors (hereinafter “P-ch transistors”). However, such a display driver involves a problem in that it is not capable of satisfactorily supplying low and medium voltages. Again, this problem is inherent to P-ch transistors in that they are capable of supplying high voltages, only.

Another alternative of a driver used in the art is a display driver having eight combinations of N-ch and P-ch transistors, the eight combinations each having a specific transmission configuration. While such a display driver is capable of supplying a relatively wide range of voltages, it requires a large chip area to operate, which gives rise to a problem of high manufacturing costs.

According to one aspect of the invention, there is provided a scanning electrode drive device for supplying a drive signal to plural scanning electrodes in a display device having plural display pixels. The plural display pixels include memory liquid crystal layers to which are applied drive voltages corresponding to data voltages and scanning voltages when the scanning voltages are applied to the scanning electrodes and the data voltages are applied to the data electrodes, the memory liquid crystal layers being provided corresponding to intersections between the plural scanning electrodes and the plural data electrodes, and the drive signal being divided into plural phases including at least four phases: a preparation phase, a selection phase, an evolution phase, and a non-selection phase, the four phases having different effective powers which are applied to the memory liquid crystal layers, and the scanning electrode driver comprising plural switch sections having at least one transistor related to one of the data voltages or one of the scanning voltages, the transistor being connected to a target scanning electrode among the plural scanning electrodes, and the switch sections each being related to any one of voltages V_{P1} and V_{P2} (which satisfy V_{P1}<V_{P2}) included at least in the drive signal during the preparation phase, voltages V_{S1}, V_{S2}, V_{S3}, and V_{S4} (which satisfy V_{S1}<V_{S2}<V_{S3}<V_{S4}, V_{S1}=V_{P1}, and V_{S4}=V_{P2}) included at least in the drive signal during the selection phase, voltages V_{E1} and V_{E2} (which satisfy V_{E1}<V_{E2}) included at least in the drive signal during the evolution phase, and voltages V_{N1} and V_{N2} (which satisfy V_{N1}<V_{N2}) included at least in the drive signal during the non-selection phase, wherein each of those of the switch sections that are related to the voltages V_{P1} and V_{N1} has an N-ch transistor, each of those of the switch sections that are related to the voltages V_{S2}, V_{S3}, V_{E1}, and V_{E2} has an N-ch transistor and a P-ch transistor which constitute a transmission configuration, and each of those of the switch sections that are related to the voltages V_{P2} and V_{N2} has a P-ch transistor. This scanning electrode drive device is able to supply eight kinds of voltages used for a DDS.

In the scanning electrode drive device, a gate width of the N-ch transistor related to the voltage V_{P1} may be smaller than a gate width of the N-ch transistor related to the voltage V_{N1}. Use of this scanning electrode drive device enables a circuit area to be reduced.

Alternatively in the scanning electrode drive device, a gate width of the P-ch transistor related to the voltage V_{P2} may be smaller than a gate width of the P-ch transistor related to the voltage V_{N2}. Use of this scanning electrode drive device enables a circuit area to be further reduced.

Also alternatively in the scanning electrode drive device, gate widths of the N-ch transistor and P-ch transistor related to the voltage V_{E1} or V_{E2} may be greater than gate widths of the N-ch transistor and P-ch transistor related to the voltage V_{S2} or V_{S3}. Use of this scanning electrode drive device enables a circuit area to be further reduced.

According to another aspect of the invention, there is provided a display driver having one of the scanning electrode drive devices described above. According to yet another aspect of the invention, there is provided an electronic device comprising both a display device and the display driver described above.

### BRIEF DESCRIPTION OF THE DRAWINGS

Embodiments of the invention will be described with reference to the accompanying drawings, wherein like numbers reference like elements:

FIG. 1 shows a configuration of an electronic book reader 100 according to an embodiment of the invention;

FIG. 2 shows a configuration of a display device 140;

FIG. 3 shows orientations of cholesteric liquid crystal;

FIG. 4 illustrates a DDS;

FIG. 5 shows transition of an orientation of cholesteric liquid crystal according to the DDS;

FIG. 6 shows an example of a drive voltage waveform in the DDS;

FIG. 7 shows a configuration of a scanning electrode driver 131; and

FIG. 8 shows a configuration of an output transistor section 4.

### DESCRIPTION OF EXEMPLARY EMBODIMENTS

An embodiment of the invention will now be described. In the embodiment, a display driver (display driver) is adopted in an electronic book reader. The electronic book reader is an electronic device having a cholesteric liquid crystal display, i.e., a display device that employs memory liquid crystal. The display device displays contents (texts or images) under control of the display driver.

1. Configuration of the Electronic Book Reader

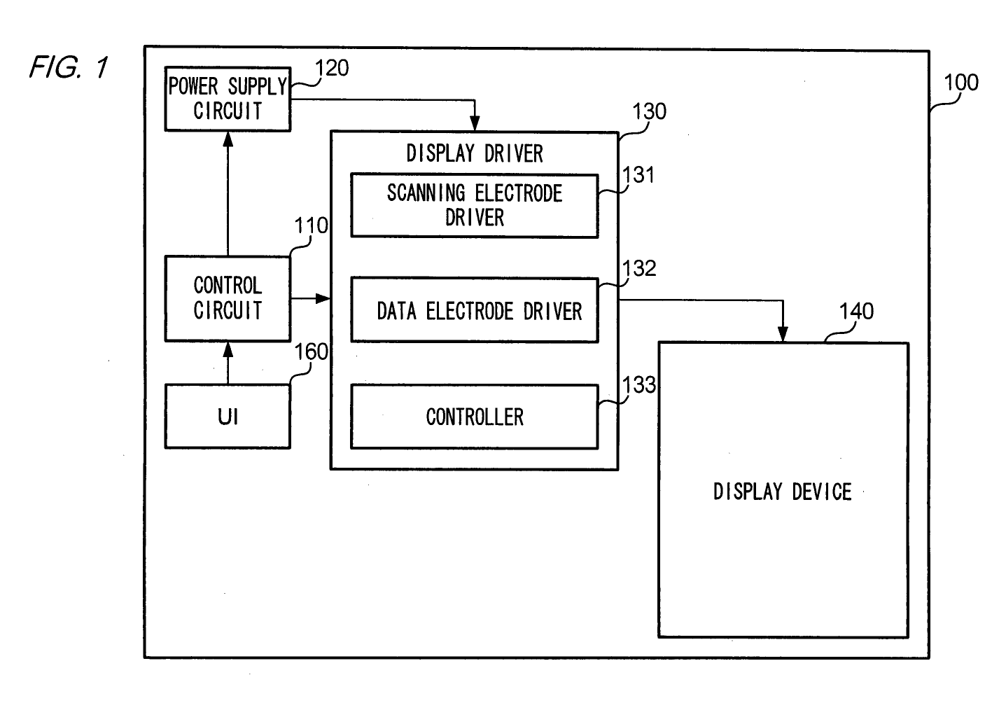

FIG. 1 shows a configuration of an electronic book reader 100 according to the embodiment of the invention. The electronic book reader 100 displays text or images in accordance with given data. A control circuit 110 controls components of the electronic book reader 100. A power supply circuit 120 is a voltage source which supplies a necessary voltage for driving a display device 140. A display driver 130 outputs signals for driving the display device 140 under control of the control circuit 110. That is, the display driver 130 drives the display device. The display device 140 has an electrooptic layer, a layer that includes electrooptic materials. A UI 160 is a user interface which allows users to input instructions to the electronic book reader 100. The UI 160 includes, for example, a rewrite button for instructing rewriting of content displayed on a screen.

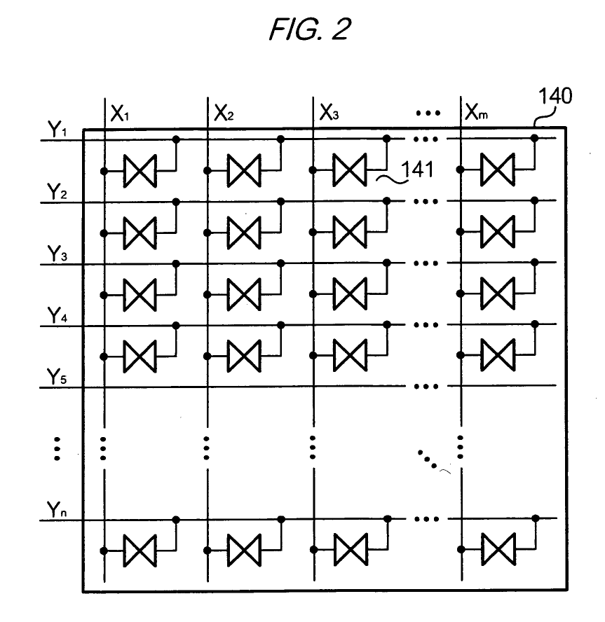

FIG. 2 shows a configuration of the display device 140. The display device 140 has an n×m matrix wire including n lines of scanning electrodes (Y₁, Y₂, . . . , Yₙ) and m columns of data electrodes (X₁, X₂, . . . , Xₘ). Here, “n” and “m” are positive integers. In this embodiment, the display device 140 is of a passive matrix type, and so, the scanning electrodes and the data electrodes respectively function as scanning lines and data lines. Electrooptic elements 141 are formed at intersecting points between the scanning electrodes and data electrodes. The electrooptic elements 141 each include two electrodes (not shown) and an electrooptic layer sealed between the two electrodes (wherein the two electrodes are a data electrode and a scanning electrode, and the data electrode is sometimes called a pixel electrode or a segment electrode, while the scanning electrode is sometimes called a common electrode). In this embodiment, a liquid crystal layer including cholesteric liquid crystal as memory liquid crystal is used as the electrooptic layer. “Memory liquid crystal” means a kind of liquid crystal capable of maintaining a displayed state without being supplied with power. The electrooptic elements 141 each are applied with voltages corresponding to a voltage applied to a related scanning electrode (hereinafter a “scanning voltage”) and also to a voltage applied to a related data electrode (hereinafter a “data voltage”). A voltage applied to the electrooptic layer is called a “drive voltage”. Chemical properties (optical rotation, light diffusion, etc.) vary depending on applied voltages. The electrooptic elements 141 create images owing to changes in chemical properties of liquid crystal. One electrooptic element 141 basically corresponds to one pixel. In a case of a color display which displays colors on RGB color coordinates, one electrooptic element 141 corresponds to any one of R, G, and B color components.

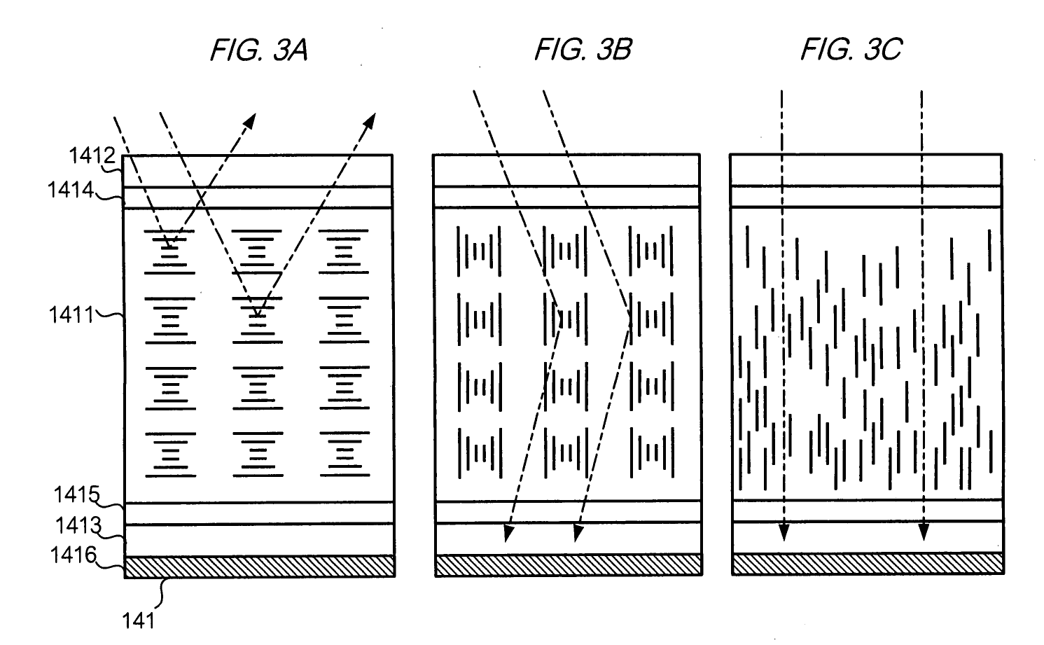

FIG. 3 shows orientations of cholesteric liquid crystal. In this embodiment, the electrooptic elements 141 each have a cholesteric liquid crystal layer 1411 sandwiched between two transparent electrodes 1414 and 1415. Further, the cholesteric liquid crystal layer 1411 and the transparent electrodes 1414 and 1415 are sandwiched between two glass substrates 1412 and 1413. A light absorption layer 1416 is provided beneath the glass substrate 1413.

A light reflectance of the cholesteric liquid crystal layer 1411 varies depending on orientations of cholesteric liquid crystal molecules. FIG. 3A shows a planar orientation (hereinafter a P-orientation). In the P-orientation, incident light is reflected, causing white to be shown on the display. FIG. 3B shows a focal conic orientation (hereinafter an F-orientation). In the F-orientation, incident light is mostly transmitted. Since transmitted light is absorbed by the glass substrate 1416, black is displayed. The orientation in the cholesteric liquid crystal layer 1411 is thus controlled to enable display of white, black, or an intermediate tone. Cholesteric liquid crystal is a bistable material and is able to maintain the P-orientation or F-orientation even in a state where no voltage is applied. In other words, a displayed state can be maintained without a voltage being applied. To switch the P-orientation and the F-orientation each other, the cholesteric liquid crystal layer 1411 needs to be once put in a homeotropic orientation (hereinafter an “H-orientation”). FIG. 3C shows an H-orientation. The h-orientation is equivalent to a state in which a spiral structure of cholesteric liquid crystal molecules has broken. At this time, incident light is transmitted. The H-orientation exists only when a voltage is applied because the H-orientation is not stable.

Description will now be made referring again to FIG. 1. The display driver 130 has a scanning electrode driver 131, a data electrode driver 132, and a controller 133. The scanning electrode driver supplies voltages to scanning electrodes. The data electrode driver supplies voltages to data electrodes. The display driver 130 has a capability to supply at least eight kinds of voltage values. The display driver 130 supplies a voltage pattern including one of eight voltage values (for example, V₁=0 V, V₂=10 V, V₃=20 V, V₄=30 V, V₅=40 V, V₆=50 V, V₇=60 V, and V₈=70 V). The term “voltage pattern” means a voltage-time characteristic within a particular time segment. In this embodiment, the display driver 130 supplies the display device 140 with a drive signal according to DDS.

2. DDS

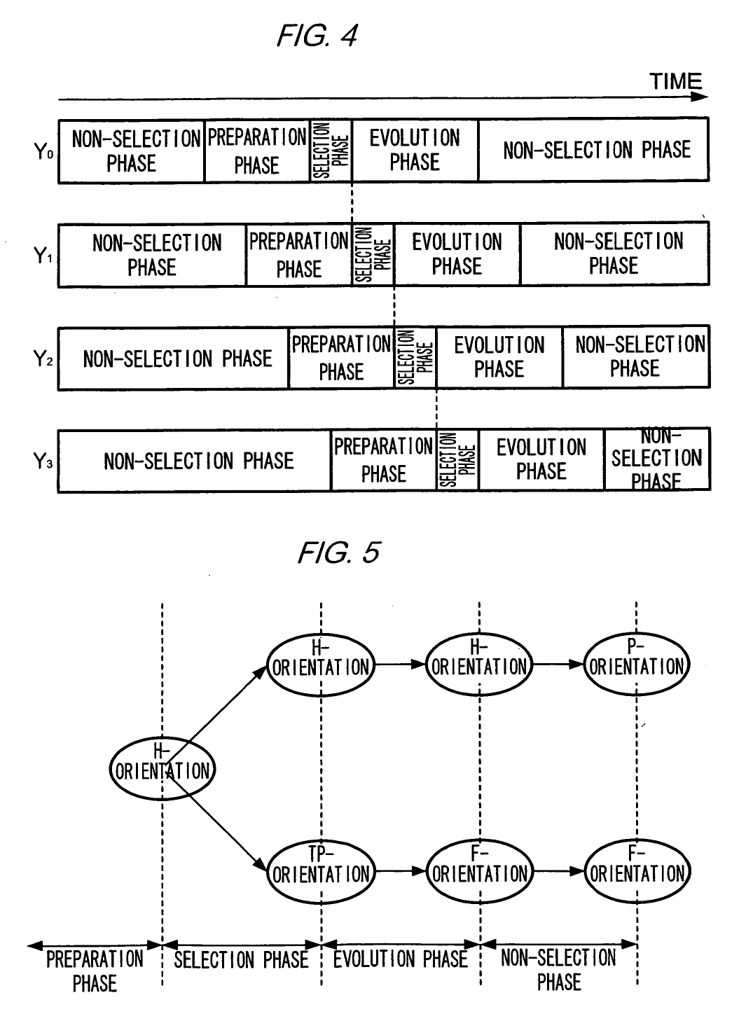

FIG. 4 illustrates the DDS. In the DDS, a voltage pattern applied to the electrooptic elements 141 is divided into four phases: a non-selection phase, a preparation phase, a selection phase, and an evolution phase. The selection phase is assigned in order to one after another of lines of pixels, the lines respectively related to scanning electrodes Y₁ to Yₙ. According to the DDS, orientation of each cholesteric liquid crystal layer 1411 is detemined by the selection phase and the successive subsequent evolution phase. Before the DDS was developed, orientation of a cholesteric liquid crystal layer had been decided only by the selection phase (hereinafter this driving method will be called “conventional drive”). According to the conventional drive, a selection phase requires a period of, for example, 50 msec or so. For example, rewriting of 2,000 lines of pixels therefore requires 100 sec or so. According to the DDS, the selection phase is shortened to 1 msec or so, and accordingly, the period required for rewriting 2,000 lines of pixels is shortened to 2 sec or so.

FIG. 5 shows transition of an orientation of cholesteric liquid crystal in the DDS. During a preparation phase, a voltage is applied to transit a P-orientation or F-orientation of liquid crystal into an H-orientation. Next in the selection phase, another voltage (hereinafter a “selection voltage” which is a drive voltage particularly during a selection phase) is applied to select a required display state (white or black in case of two tone gradient, i.e., P-orientation or F-orientation). In this embodiment, the cholesteric liquid crystal layer is transited to the H-orientation or a transit planar orientation (hereinafter a “TP-orientation”) by the selection voltage. The TP-orientation is an intermediate state between the H-orientation and the P-orientation, in which a spiral structure of liquid crystal molecules is slightly relaxed. Next during the evolution phase, a voltage (hereinafter a “sustaining voltage”) is applied to maintain a required displayed state. The liquid crystal layer transited to the H-orientation by the selection voltage is maintained in the H-orientation. The liquid crystal layer transited to the TP-orientation by the selection voltage is transited to the F-orientation (a black display state). Next during the non-selection phase, the voltage is canceled (although the voltage does not strictly become zero in some cases). The liquid crystal layer maintaining the H-orientation due to a sustaining voltage is transited to the P-orientation (a white display state).

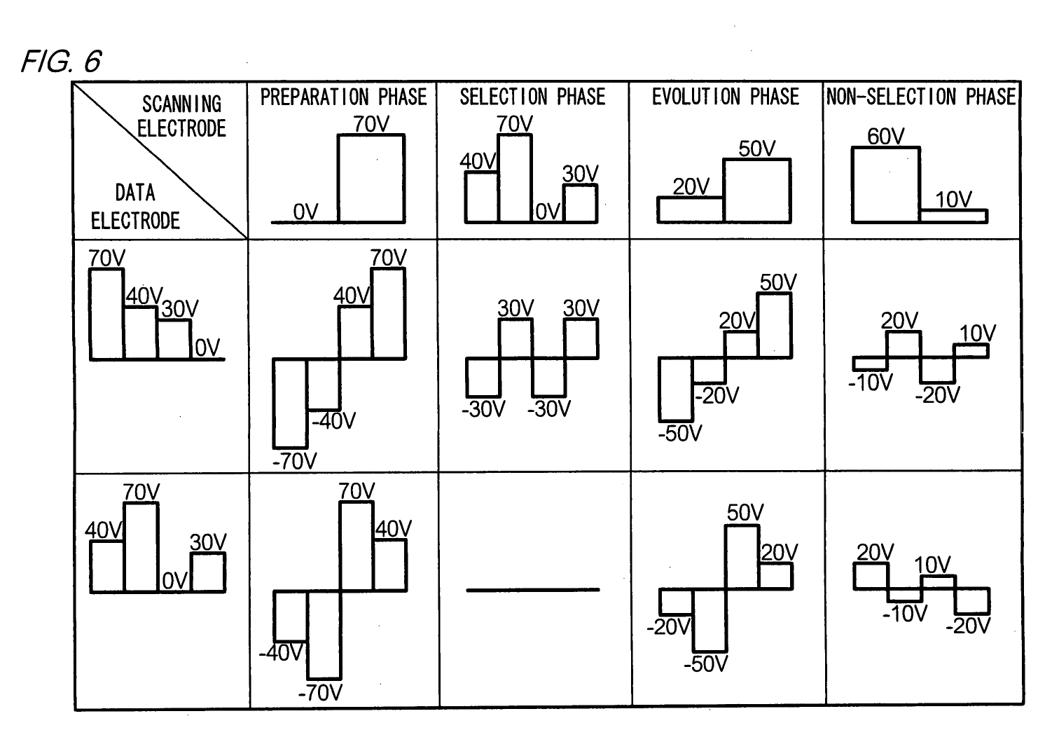

FIG. 6 shows examples of drive voltage waveforms according to the DSS. As shown in FIG. 6, a voltage pattern including at least two kinds of voltage values is applied during each of the non-selection phase, preparation phase, selection phase, and evolution phase. Voltages applied during the non-selection phase, preparation phase, selection phase, and evolution phase are respectively expressed as V_{N}, V_{P}, V_{S}, and V_{E}. For example, two kinds of voltages applied during the non-selection phase are distinguished from each other using appended reference numerals, such as V_{N1} and V_{N2}. Ascending numerals are assigned as the appended reference numerals to voltages in ascending order from the voltage having the smallest absolute value. This manner of assigning appended reference numerals also applies to the other phases. FIG. 6 shows an example where V_{P1}=0 V, V_{P2}=70 V, V_{S1}=0 V, V_{S2}=30 V, V_{S3}=40 V, V_{S4}=70 V, V_{E1}=20 V, V_{E2}=50 V, V_{N1}=10V, and V_{N2}=60V). In this example, data electrodes are applied with a voltage pattern including four kinds of voltage values of V_{SEG1} to V_{SEG4}. In the example of FIG. 6, V_{SEG1}=0 V, V_{SEG2}=30 V, V_{SEG3}=40 V, and V_{SEG4}=70 V. In the DDS, the same effective voltages are applied to electrooptic elements during each of the phases except the selection phase, regardless of whether the voltage pattern applied to a data electrode corresponds to white or black, as shown in FIG. 6. Only during the selection phase, the effective voltages applied to the electrooptic elements differ corresponding to tone values to be displayed. In the DDS, the orientation of liquid crystal is determined by the effective voltage. Thus in this embodiment, the display driver 130 uses eight kinds of voltage values.

3. Configuration of the Display Driver

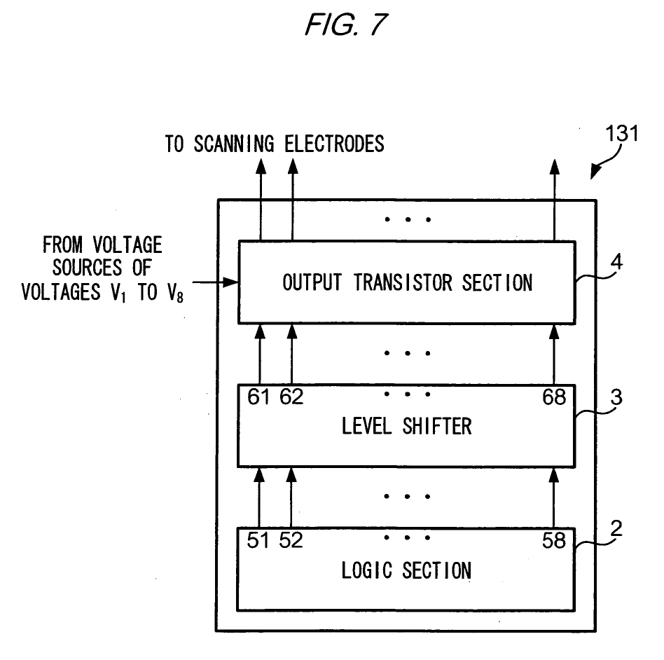

FIG. 7 shows a configuration of the scanning electrode driver 131. FIG. 7 shows only a part of the configuration that relates to one scanning electrode, to avoid a complex drawing. As shown in FIG. 7, the scanning electrode driver 131 has a logic section 2, level shifter 3, and output transistor section 4.

The logic section 2 generates control signals 51 to 58 to each of the scanning electrodes under control of a controller 133. The control signals 51 to 58 each are a signal for selecting a voltage value from among eight voltage values in a voltage pattern. That is, these control signals are for selecting voltages to be output to a scanning electrode. The control signals include a signal for inducing supply of a voltage and a signal for inhibiting it. The signal for inducing supply of a voltage is, for example, a high level signal. The signal for inhibiting supply of a voltage is, for example, a low level signal.

The level shifter 3 generates control signals 61 to 68. The control signals 61 to 68 are respectively related to the control signals 51 to 58 supplied from the logic section 2. That is, the control signals 61 to 68 each correspond to any of eight voltage values included in a voltage pattern. The control signals 61 to 68 are high level signals. A control signal 5x and a control signal 6x have different voltage values. The high level control signals 61 to 68 have higher voltages than a threshold voltage which turns on gates of N-ch transistors in the output transistor section 4. As the high level control signals 61 to 68 pass through an inversion circuit, these control signals have higher voltages than a threshold voltage which turns on gates of P-ch transistors. If the control signals 51 to 58 are low level signals, the control signals 61 to 68 are also low level signals. Though the control signal 5x and the control signal 6x are low level signals, these signals have different voltage values. The control signals 61 to 68 have lower voltages than the threshold voltage which turns on the gates of the N-ch transistors in the output transistor section 4. As the low level control signals 61 to 68 pass through an inversion circuit, these control signals have lower voltages than the threshold value which turns on the gates of the P-ch transistors.

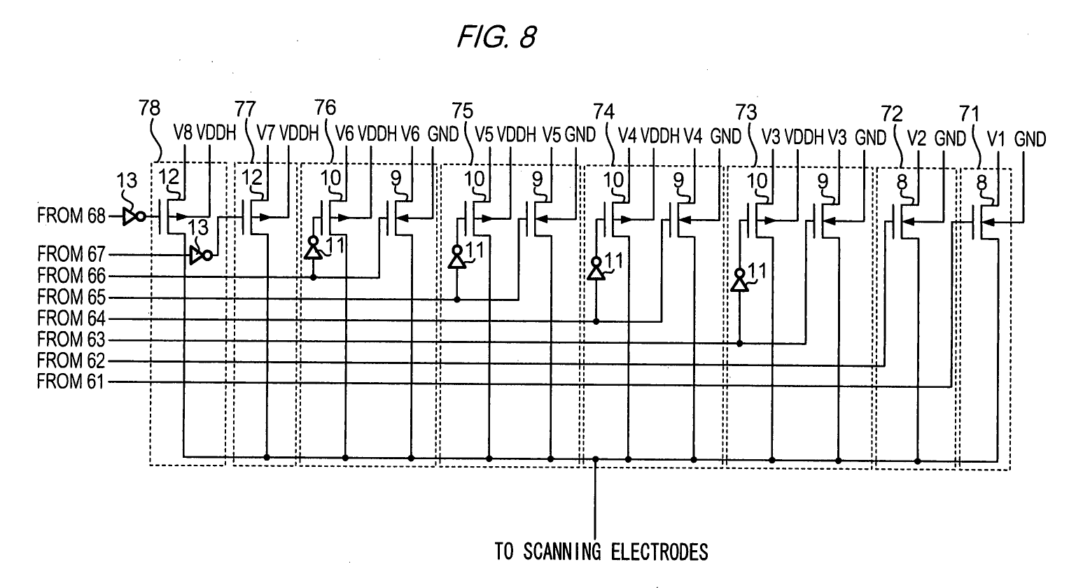

FIG. 8 shows a configuration of the output transistor section 4. The output transistor section 4 has eight switches, i.e., first to eighth switches 71 to 78. The switches 71 to 78 each are related to any of eight kinds of voltages. More specifically, the switches 71, 72, . . . , 78 are respectively related to voltages V₁, V₂, . . . , V₈. The voltages V₁ to V₈ each are supplied from a voltage source (a power supply circuit 120). According to the control signals 61 to 68, the switches 71 to 78 respectively supply related voltages to the scanning electrodes or data electrodes selectively.

More specifically, the output transistor section 4 has a configuration as follows. The switches 71 and 72 as the first and second switches each include an N-ch transistor 8. A drain of the N-ch transistor 8 is connected to a voltage source of a voltage V₁ or V₂. A source of the N-ch transistor 8 is connected to a scanning electrode or data electrode. A gate of the N-ch transistor 8 is connected to an output of the level shifter 3. A back gate of the N-ch transistor 8 is grounded. A gate width W₁ (e.g., a channel region) of the N-ch transistor 8 connected to the voltage source of the voltage V₂ (equivalent to a voltage V_{P1}) may be smaller than a gate width W₂ of the N-ch transistor connected to the voltage source of the voltage V₂ (equivalent to a voltage V_{N1}). That is, W₁<W₂ may be given.

If a high level control signal is inputted to the gate of an N-ch transistor 8 from a level shifter 3, the drain and source of the N-ch transistor 8 are electrically connected to each other. As a result, the voltage V₁ or V₂ supplied to the drain is then fed to a scanning electrode or data electrode connected to the source. Otherwise, if a low level control signal is inputted to the gate of the N-ch transistor 8, the drain and source of the N-ch transistor 8 are electrically disconnected from each other. As a result, the voltage V₁ or V₂ supplied to the drain is not fed to the scanning electrode or data electrode connected to the source.

The switches 73 to 76 as the third to sixth switches each have a transmission configuration including an N-ch transistor 9 and a P-ch transistor 10. The transmission configuration means a configuration in which an N-ch transistor and a P-ch transistor are connected in parallel. A drain of the N-ch transistor 9 is connected to a voltage source of voltages V₃ to V₆. A source of the N-ch transistor 9 is connected to a scanning electrode or data electrode. A gate of the N-ch transistor 9 is connected to an output of the level shifter 3. A back gate of the N-ch transistor 9 is grounded. A drain of the P-ch transistor 10 is connected to a voltage source of voltages V₃ to V₆. A source of the P-ch transistor 10 is connected to a scanning electrode or data electrode. A gate of the P-ch transistor 10 is connected to an output of the level shifter 3 through an inversion circuit 11 (which inverts a high level voltage to a low level voltage or visa versa). A back gate of the P-ch transistor 10 is connected to a voltage source VDDH.

If the control signals 63 to 66 are at a high level, the drain and source of each of the N-ch transistor 9 and P-ch transistor 10 are electrically connected to each other. As a result, each of the voltages V3 to V6 supplied to the drains is then fed to a scanning electrode or data electrode. Otherwise, if the control signals 63 to 66 are at a low level, the drain and source of each of the N-ch transistor 9 and P-ch transistor 10 are electrically disconnected from each other. As a result, each of the voltages V₃ to V₆ supplied to the drains is fed to neither a scanning electrode nor data electrode. Gate widths of the N-ch transistor and P-ch transistor which are related to the voltage V₃ or V₆ (equivalent to a voltage V_{E1} or V_{E2}) may be greater than gate widths of the N-ch transistor and P-ch transistor which are related to the voltage V₄ or V₅ (equivalent to a voltage V_{S2} or V_{S3}).

The switches 77 and 78 as the seventh and eighth switches each include a P-ch transistor 12. A drain of the P-ch transistor 12 is connected to a voltage source of the voltage V₇ or V₈. A source of the P-ch transistor 12 is electrically connected to a scanning electrode or data electrode. A gate of the P-ch transistor 12 is connected to the level shifter 3 through an inversion circuit 13 (which inverts and outputs high level and low level voltages). A back gate of the P-ch transistor 12 is connected to the voltage source VDDH. A gate width W₇ of the P-ch transistor 12 connected to the voltage source of the voltage V₇ (equivalent to V_{N2}) may be greater than a gate width W₈ of the P-ch transistor 12 connected to a voltage source of the voltage V₈ (equivalent to V_{P2}).

If the control signal 67 or 68 is at a high level, the source and drain of the P-ch transistor 12 are electrically connected to each other. As a result, the voltage V₇ or V₈ supplied to the drain is then fed to a scanning electrode or data electrode connected to the source. Otherwise, if the control signal 67 or 68 is at a low level, the source and drain of the P-ch transistor 12 are electrically disconnected from each other. As a result, the voltage V₇ or V₈ is supplied to neither a scanning electrode nor a data electrode.

The above description has been made of the scanning electrode driver 131. The data electrode driver 132 has the same configuration as the driver 131. However, the data electrode driver 132 need not output eight kinds of voltages and hence may have a smaller number of switches than eight. In the examples of the waveforms shown in FIG. 6 it is necessary to supply only four kinds of voltages.

4. Operation of an Electronic Book Reader

Operation of an electronic book reader according to the present embodiment will be described next.

A case is first assumed where an input request for inputting a voltage V₆ to a target scanning electrode is given according to a DDS. For example, this case takes place triggered by a content switch request for switching contents on the cholesteric liquid crystal display. The content switch request is inputted, for example, through the UI 160. The logic section 2 supplies a high level signal as a control signal 56 (which is a signal corresponding to the voltage V₆). The logic section 2 supplies low level signals as control signals 51 to 55, 57, and 58 (which are signals corresponding to the other voltages than the voltage V₆). That is, a signal for inducing supply of the voltage V₆ is outputted as the control signal 56. Signals for inhibiting supply of voltages V₁ to V₅ and V₇ to V₈ are outputted as the control signals 51 to 55, 57, and 58.

The level shifter 3 supplies a high level signal as a control signal 66. The level shifter 3 also supplies low level signals as control signals 61 to 65 and 67 to 68. Low level voltages are inputted to the gates of N-ch transistors 8 in the switches 71 and 72 in the output transistor section 4. As a result, the drain and source of each N-ch transistor 8 are electrically disconnected from each other. That is, neither the voltage V₁ nor V₂ is supplied to the target scanning electrode.

In each of the switches 73 to 75, a low level voltage is inputted to the N-ch transistor 9, and a high level voltage is inputted to the gate of the P-ch transistor 10 from the inversion circuit 11. As a result, the drain and source of each of the N-ch transistor 9 and P-ch transistor 10 are electrically disconnected from each other. That is, none of the voltages V₃ to V₅ is supplied to the target scanning electrode.

In the switch 76, a high level voltage is inputted to the gate of the N-ch transistor, and a low level voltage is inputted to the gate of the P-ch transistor 10. As a result, the drain and source of each of the N-ch transistor 9 and P-ch transistor 10 are electrically connected to each other. That is, the voltage V₆ is supplied to the target electrode.

In each of the switches 77 and 78, a low level voltage is inputted to the inversion circuit 13. A high level voltage is inputted to the gate of the P-ch transistor 12 from the inversion circuit 13. As a result, the drain and source of the P-ch transistor are electrically disconnected from each other. That is, neither the voltage V₇ nor V₈ is inputted to the target scanning electrode. To summarize the above, the target electrode is not supplied with any of the voltages V₁ to V₅ and V₇ to V₈ but is supplied only with the voltage V₆.

The above description has been made of an example in which a drive signal is supplied to a scanning electrode. Drive signals for data electrodes are supplied in the same manner as described above. Desired voltages are thus applied to electrooptic elements. In other words, redrawing of the display can be achieved.

As has been described above, the display driver 130 according to this embodiment uses a switch having an N-ch transistor 8 for a voltage source of a lower voltage among eight kinds of voltages which the display driver 130 can supply, as well as a switch having a P-ch transistor 12 for a voltage source of a higher voltage. A switch having an N-ch transistor and a P-ch transistor, which form a transmission configuration, is used for a voltage source of an intermediate voltage between the higher and lower voltages. Compared with an N-ch transistor, a P-ch transistor is more suitable for supply of a high voltage. Therefore, the display driver 130 according to this embodiment is able to satisfactorily supply voltages used for driving the display device 140. Further, manufacturing costs for the display driver can be further reduced compared with a case that two transistors (an N-ch transistor and a P-ch transistor) forming a transmission configuration are used in every switch.

The gate width W₁ of the N-ch transistor 8 related to the voltage V₁ may be smaller than the gate width W₂ of the N-ch transistor 8 related to the voltage V₂. Further, the gate width W₈ of the P-ch transistor 12 related to the voltage V₈ may be smaller than the gate width W₈ of the P-ch transistor related to the voltage V₇. This configuration can allow the display driver to have a smaller chip area. For example, manufacturing costs can be further reduced compared with a method of using transistors having an equal gate width as the N-ch (or P-ch) transistors 8 (or transistors 12) related to voltages V₁ and V₂ (or V₇ and V₈).

Even when voltage values of V3 to V6 applied according to the DDS need to be changed, flexible changes can be made by use of an N-ch transistor and a P-ch transistor forming a transmission configuration.

5. Further Embodiments

The invention is not limited to the above embodiment but can be variously modified.

The voltage waveforms used in DDS are not limited to those shown in FIG. 6. Any voltage waveform may be used as long as several conditions are satisfied. The conditions are: liquid crystal can be transited to a desired orientation; and only in the selection phase among four phases, effective voltages applied to electrooptic elements differ corresponding to tones to be displayed. The numbers of voltages used in individual phases are not limited to those shown in FIG. 6. For example, a voltage pattern including three or more kinds of voltages may be used in the non-selection phase. Alternatively, a voltage pattern including three or less kinds of voltages or including five or more kinds of voltages may be used in the selection phase. Voltage values are not limited to those shown in FIG. 6, either. Voltage values are determined based on a physical structure of the display device 140 or the like. In brief, it suffices that: the drive signal during the preparation phase includes at least voltages V_{P1} and V_{P2} (which satisfy V_{P1}<V_{P2}); the drive signal during the selection phase includes at least voltages V_{S1}, V_{S2}, V_{S3}, and V_{S4} (which satisfy V_{S1}<V_{S2}<V_{S3}<V_{S4}, V_{S1}=V_{P1}, and V_{S4}=V_{P2}); the drive signal during the evolution phase includes at least voltages V_{E1} and V_{E2} (which satisfy V_{E1}<V_{E2}); and the drive signal during the non-selection phase includes at least voltages V_{N1} and V_{N2} (which satisfy V_{N1}<V_{N2}).

In the above embodiment, voltage values used in the voltage patterns applied to data electrodes are the same as voltage values (or a part thereof) used in the voltage pattern applied to scanning electrodes. That is, voltages which the data electrode driver 132 is capable of supplying are the same as voltages (or parts thereof) which the scanning electrode driver 131 is capable of supplying. However, voltages which the data electrode driver 132 is capable of supplying need not always be the same as voltages (or parts thereof) which the data electrode driver 132 is capable of supplying. For example, if two voltage values are used for scanning electrodes during each of the preparation phase, selection phase, evolution phase, and non-selection phase, the scanning electrode driver 131 needs a function of supplying eight voltage values. If further two voltage values are used for data electrodes separately from these voltages, the data electrode driver 132 needs a function of supplying these two voltage values. In this case, the display driver 130 has a function capable of supplying ten voltage values in total.

The scanning electrode driver 131 (or data electrode driver 132) may further have a function of switching voltages according to an external signal. In this case, a switch (transistor) is provided in the driver to mutually switch voltage sources for V_{E1} and V_{E2}, for example. This function is capable of replacing voltages of the V_{E1}, and V_{E2} with each other. A similar function may be provided for V_{S1} and V_{S2}.

The above embodiment has been described with reference to an example in which a scanning electrode drive device is applied to an electronic book reader. However, the scanning electrode drive device according to the invention may be applied to other electronic devices (such as a document reader, an electronic paper device, etc.) than the electronic book reader. In brief, the scanning electrode drive device according to the invention is applicable to any electronic device as long as the electronic device has a display device including a memory liquid crystal layer.

What is claimed is:

1. A scanning electrode driver for supplying a drive signal to a plurality of scanning electrodes in a display device having a plurality of display pixels, the plurality of display pixels respectively including memory liquid crystal layers that are applied with drive voltages corresponding to data voltages and scanning voltages when the scanning voltages are applied to the scanning electrodes and the data voltages are applied to the data electrodes, the memory liquid crystal layers being provided corresponding to intersections between the plurality of scanning electrodes and a plurality of data electrodes, and the drive signal being divided into a plurality of phases including at least four phases, the four phases being a preparation phase, a selection phase, an evolution phase, and a non-selection phase, the four phases applying different effective powers to the memory liquid crystal layers, the scanning electrode driver comprising
a plurality of switch sections, each of the plurality of switch sections having at least one transistor related to one of the data voltages or one of the scanning voltages, the transistor being connected to a target scanning electrode among the plurality of scanning electrodes, and the switch sections each being related to any one of voltages V_{P1} and V_{P2} (which satisfy V_{P1}<V_{P2}) included at least in the drive signal during the preparation phase, voltages V_{S1}, V_{S2}, V_{S3}, and V_{S4} (which satisfy V_{S1}<V_{S2}<V_{S3}<V_{S4}, V_{S1}=V_{P1}, and V_{S4}=V_{P2}) included at least in the drive signal during the selection phase, voltages V_{E1} and V_{E2} (which satisfy V_{E1}<V_{E2}) included at least in the drive signal during the evolution phase, and voltages V_{N1} and V_{N2} (which satisfy V_{N1}<V_{N2}) included at least in the drive signal during the non-selection phase, wherein
each of those of the switch sections that are related to the voltages V_{P1} and V_{N1} has an N-ch transistor,
each of those of the switch sections that are related to the voltages V_{S2}, V_{S3}, V_{E1}, and V_{E2} has an N-ch transistor and a P-ch transistor which constitute a transmission configuration, and
each of those of the switch sections that are related to the voltages V_{P2} and V_{N2} has a P-ch transistor.

2. The scanning electrode drive device according to claim 1, wherein a gate width of the N-ch transistor related to the voltage V_{P1} is smaller than a gate width of the N-ch transistor related to the voltage V_{N1}.

3. The scanning electrode drive device according to claim 1, wherein a gate width of the P-ch transistor related to the voltage V_{P2} is smaller than a gate width of the P-ch transistor related to the voltage V_{N2}.

4. The scanning electrode drive device according to claim 1, wherein gate widths of the N-ch transistor and P-ch transistor related to the voltage V_{E1} or V_{E2} are greater than gate widths of the N-ch transistor and P-ch transistor related to the voltage V_{S2} or V_{S3}.

5. A display driver having the scanning electrode drive device according to claims 1.

6. An electronic device comprising:
a display device; and
the display driver according to claim 5.
